(19) United States
(12) Patent Application Publication
(10) Pub. No.: US 2022/0282564 A1
(43) Pub. Date: Sep. 8, 2022

(54) DOOR SHOE

(71) Applicant: ASSA ABLOY Accessories and Door Controls Group, Inc., Monroe, NC (US)

(72) Inventors: Ellen Amanda Swofford, Olive Branch, MS (US); Gary Lawrence Higginbotham, JR., Savannah, TN (US)

(73) Assignee: ASSA ABLOY Accessories and Door Controls Group, Inc., Monroe, NC (US)

(21) Appl. No.: 17/676,616

(22) Filed: Feb. 21, 2022

Related U.S. Application Data
(60) Provisional application No. 63/155,552, filed on Mar. 2, 2021.

(51) Int. Cl. E06B 7/23

(52) U.S. Cl. CPC E06B 7/2316

(57) ABSTRACT

A door system having a door shoe including a first shoe member and a second shoe member that provide a thermal break between the members, which reduces heat transfer between the members. One or more gaskets may be operatively coupled to the first shoe member or the second shoe member. The first shoe member and the second shoe member can be operatively coupled to the door to cover different sized gaps located between the bottom edge of the door and a floor. As such, the door shoe disclosed herein may be used to cover different size gaps, provide a thermal break between the members to aid in fire resistance, and be easily installed on doors without having to remove the door from the frame.

### CROSS REFERENCE AND PRIORITY CLAIM UNDER 35 U.S.C. § 119

This application claims priority to U.S. Provisional Application No. 63/155,552 entitled “Door Shoe” filed on Mar. 2, 2021, which is assigned to the assignee hereof, and the entirety of which is incorporated by reference herein.

### FIELD

The present disclosure generally relates to door shoes, and in particular, to a two piece door shoe that allows for improved fire resistance.

### BACKGROUND

Gaps in door openings can occur over time when a building settles, flooring is changed, a door is improperly sized, or the like.

### SUMMARY

Embodiments of the invention relate to a door system having a door shoe including a first shoe member and a second shoe member that provide a thermal break between the members, which reduces heat transfer between the members. The first shoe member may be configured to be operatively coupled to an interior face of a door. The second shoe member may be configured to be operatively coupled to an exterior face of a door. Alternatively, the first shoe member may be configured to be operatively coupled to an exterior face of a door and the second shoe member may be configured to be operatively coupled with an interior face of a door. One or more gaskets may be configured to be operatively coupled to the first shoe member or the second shoe member. It should be understood that the first shoe member and the second shoe member can be operatively coupled to the door to cover different sized gaps located between the bottom edge of the door and a floor. As such, the door shoe disclosed herein may be used to cover different size gaps, provide a thermal break between the members to aid in fire resistance, and/or be easily installed on doors without having to remove the door from the frame.

One embodiment of the present disclosure comprises door shoe. The door shoe comprises a first shoe member configured to be operatively coupled to a first face of a door and a second shoe member configured to be operatively coupled to a second face of the door. One or more gaskets are operatively coupled to the first shoe member or the second shoe member. The first shoe member and the second shoe member are configured to be operatively coupled to the door with a thermal break formed between the first shoe member and the second shoe member.

In further accord with embodiments, the first shoe member or the second shoe member are made from aluminum.

In other embodiments, the first shoe member is an L-shaped member having an upper flange and a lower flange.

In still other embodiments, the lower flange of the first shoe member is configured to extend across a majority of a bottom edge between the first face and the second face of the door.

In yet other embodiments, the second shoe member is a planer-shaped member having at least one straight portion.

In other embodiments, the first shoe member is a first L-shaped member having a first upper flange and a first lower flange, and the second shoe member is a second L-shaped member having a second upper flange and a second lower flange. The first upper flange of the first shoe member is configured to be operatively coupled to the first face of the door and the second upper flange is configured to be operatively coupled to the second face of the door.

In further accord with embodiments, the door shoe further comprises one or more end caps. The one or more end caps cover at least a portion of the door and a portion of a door shoe cavity formed between a bottom edge of the door and the first shoe member or the second shoe member.

In other embodiments, the one or more gaskets comprise a first gasket adjacent the first face of the door and a second gasket adjacent the second face of the door.

In still other embodiments, the one or more gaskets comprise two or more legs and the two or more legs are configured to engage with a floor.

In yet other embodiments, the one or more gaskets extend from the first shoe member or the second shoe member adjacent a bottom edge of the door between the first face and the second face towards a floor.

In other embodiments, the first shoe member or the second shoe member comprise a first channel and a second channel. The first gasket is configured to be operatively coupled to the first channel and the second gasket is configured to be operatively coupled to the second channel. The door shoe further comprises an outer intumescent portion configured to be operatively coupled to an outer surface of a lower flange of the first shoe member or the second shoe member between the first gasket and the second gasket. The door shoe further comprises an inner intumescent portion configured to be operatively coupling to an inner surface of the lower flange of the first shoe member or the second shoe member.

Another embodiment of the present disclosure comprises a door system. The door system comprises a door and a door shoe operatively coupled to the door. The door shoe comprises a first shoe member operatively coupled with a first face of the door and a second shoe member operatively coupled with a second face of the door. One or more gaskets are operatively coupled to the first shoe member or the second shoe member. The first shoe member and the second shoe member are operatively coupled to the door with a space formed between to create a thermal break between the first shoe member and the second shoe member.

In further accord with embodiments, the first shoe member and the second shoe member of the door shoe are made from aluminum.

In other embodiments, the first shoe member is an L-shaped member having an upper flange and a lower flange.

In still other embodiments, the lower flange of the first shoe member extends across a majority of a bottom edge between the first face and the second face of the door.

In yet other embodiments the door system further comprises one or more end caps. The one or more end caps cover at least a portion of the door and a portion of a door shoe cavity formed between a bottom edge of the door and the first shoe member or the second shoe member.

In other embodiments, the one or more gaskets comprise a first gasket adjacent the first face of the door, and a second gasket adjacent the second face of the door.

In further accord with embodiments, the one or more gaskets comprise two or more legs, which are configured to engage with a floor.

In other embodiments, the first shoe member or the second shoe member comprises a first channel and a second channel. The first gasket is operatively coupled to the first channel and the second gasket is operatively coupled to the second channel. The first gasket and the second gasket extend from the first shoe member or the second shoe member adjacent a bottom edge of the door between the first face and the second face towards a floor. The door shoe further comprises an outer intumescent portion operatively coupled to an outer surface of a lower flange of the first shoe member or the second shoe member between the first gasket and the second gasket. The door shoe further comprises an inner intumescent portion operatively coupled to an inner surface of the lower flange of the first shoe member or the second shoe member.

Another embodiment of the present disclosure comprises a method of installing a door shoe to a door. The method comprises assembling a first shoe member to a first face of the door using one or more door shoe connectors, and assembling a second shoe member to a second face of the door using the one or more door shoe connectors. The first shoe member and the second shoe member are spaced apart to form a thermal break between the first shoe member and the second shoe member. One or more gaskets are operatively coupled to the first shoe member or the second shoe member and engage a floor.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings.

FIG. 1 is a front view of a door system having a door shoe, in accordance with embodiments of the present disclosure.

FIG. 2 is a perspective partial view of a door with a door gap.

FIG. 3 is a perspective partial view of a door with the door shoe installed, in accordance with embodiments of the present disclosure.

FIG. 4 is a perspective end view of a door shoe installed on a door, in accordance with embodiments of the present disclosure.

FIG. 5 illustrates an end view of a door shoe installed on a door, in accordance with embodiments of the present disclosure.

FIG. 6 is a method of manufacturing, assembling, and installing a door shoe having at least two pieces, in accordance with embodiments of the present disclosure.

### DETAILED DESCRIPTION

The following detailed description teaches specific example embodiments of the invention; however, other embodiments of the invention do not depart from the scope of the present invention. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “have”, “including”, “having”, or other like terms when used herein, specify the presence of stated features, steps, operations, elements, and/or components, but do not preclude the presence or addition of one or more other features, steps, operations, elements, components, and/or groups thereof.

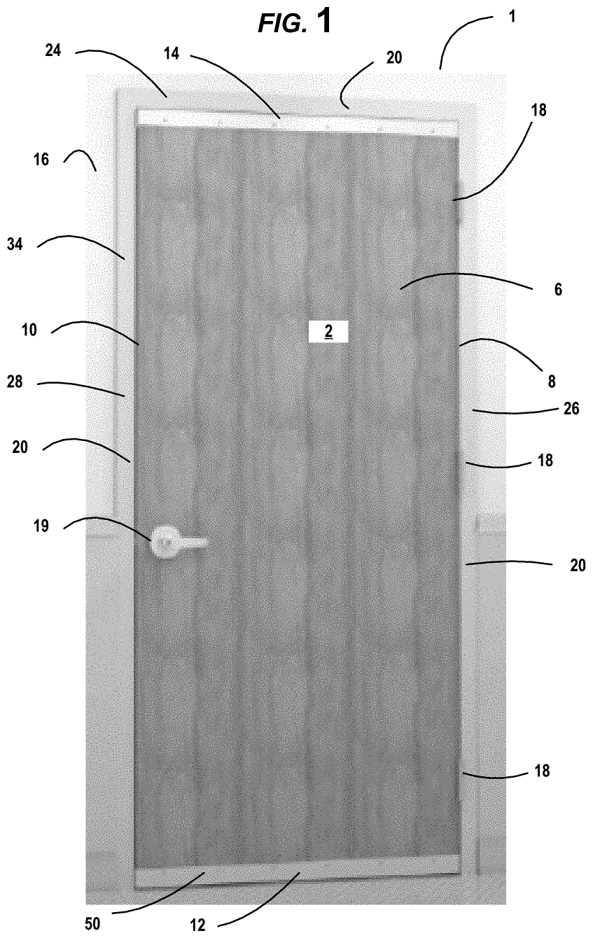

Referring now to the drawings, wherein like reference numerals designate corresponding or similar elements throughout the several views, embodiments of a door system 1 having a door shoe 50 are shown in FIGS. 1 and 3 through 5. As illustrated in FIG. 1, the door system 1 may comprise a door 2 having a first face 4 (e.g., an interior face), a second face 6 (e.g., an outer face), opposing edges 8, 10 (e.g., a first edge 8, and a second edge 10, a bottom edge 12 (e.g., a lower edge, or the like), and top edge 14 (e.g., an upper edge, or the like). Moreover, the door system 1 may further comprise a door frame 20. As illustrated in FIG. 1, the door frame 20 may comprise three (3) portions including an upper portion 24 disposed adjacent an upper end of a door opening, and two side portions (e.g., a first frame portion 26 and a second frame portion 28) disposed along either edge of the door opening, with one side portion 26 being on the hinge 18 side of the door, and the opposite side portion 28 being on the latch 19 side of the door. Each portion 24, 26, 28 may be made up of one or more elongated frame segments of sufficient length to fit the door opening and door 2. The one or more frame segments are assembled around the opening edges of wall 16. The door 2 may be hung conventionally within the door opening by hinges 18 secured by fasteners (not illustrated) through openings to hinge reinforcements (not illustrated) in one or both of frame side portions 26, 28. The inner or outer door faces 4, 6 may contact stop flanges of the door frame 20. It should be understood that while a particular door system 1 is illustrated, the door shoe 50 of the present disclosure may be implemented in any door system 1 having any type of door 2 and/or door frame 20. For example, the door 2 may be made of any type of material or combinations of materials, such as steel, composite, hollow metal, wood, plastic, plastic covered, steel covered, laminated, coated, or the like. Moreover, the door system 1 may include other types of door seals, such as a header seal 30 operatively coupled adjacent a top edge 14 of the door 2 and/or side jamb seals (e.g., not illustrated) operatively coupled to side edges 8, 10 of the door 2.

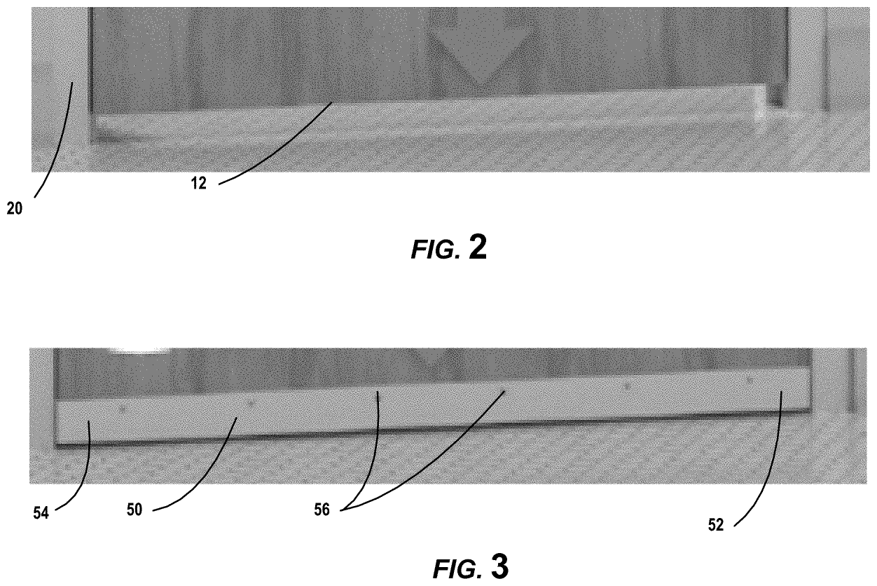

As illustrated in FIG. 2, gaps in door openings may occur by design (e.g., based on the original use of a room and/or building), may occurs due to improper sizing of the door, and/or can occur over time when a building settles, flooring is changed, or the like. However, when a particular fire rating is required or is not met, due to changes in the gap over time, retrofitting of an original room and/or building, or the like, additional hardware may be needed to bring the door system 1 up to code in order to meet fire resistance requirements. As such, the door header seals 30, jamb seals, and/or door shoes 50 may be used in a door system 1 in order to meet fire codes, including bringing a non-compliant door 2 into compliance.

As such, in the present door system 1, a door shoe 50 may be utilized for operative coupling adjacent the bottom edge 12 of the door 2 in order to account for gaps between the bottom edge 12 of the door 2 and the floor. The door shoe 50 of the present invention may comprise a first shoe member 60 and a second shoe member 70. The first shoe member 60 may be configured to be operatively coupled to a first face 4 of a door 2, which in some embodiments comprises an interior face 4 of a door 2 (e.g., face of the door that encloses a room). The second shoe member 70 may be configured to be operatively coupled to a second face 6 of a door 2 (e.g., exterior face of the door on the outside of a room and/or building). Moreover, one or more gaskets 100 may be operatively coupled to the first shoe member 60 or the second shoe member 70, as will be described in further detail herein. The door shoe 50 may have a proximal end 52 and a distal end 54, and thus the first shoe member 60 and the second shoe member 70 may have proximal ends and distal ends. The proximal end 52 and distal end 54 of the door shoe 50 may extend from adjacent a first edge 8 to adjacent a second edge 10 of the door 2 (e.g., expanding a width of the door 2 at the bottom edge 12 of the door 2). While the proximal end 52 may be illustrated as being adjacent the first edge 8 of the door 2 and the distal end 54 may be illustrated as being adjacent the second edge 10 of the door 2, it should be understood that the terminology may be reversed and the door shoe 50 may operate in the same way.

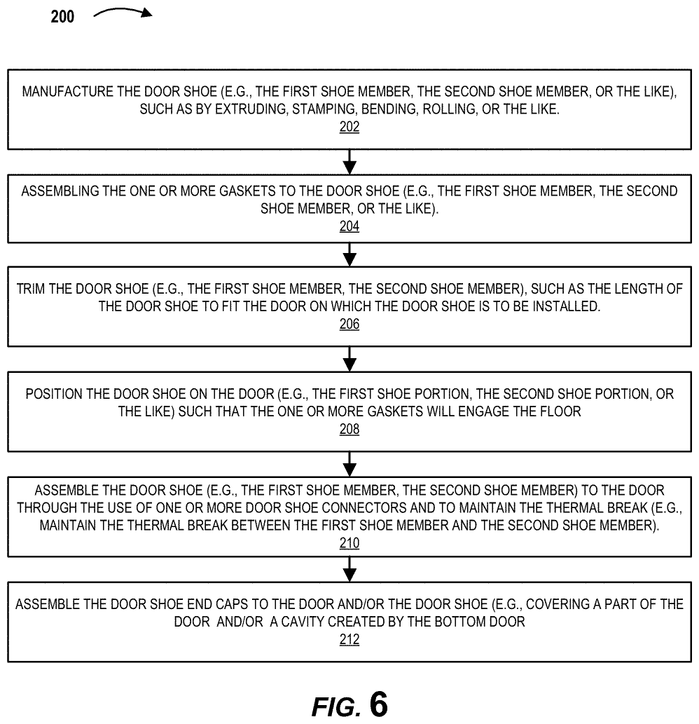

In some embodiments, the first shoe member 60 may comprise an L-shaped member having an upper flange 62 and a lower flange 64 operatively coupled together (e.g., integrally formed, separate flanges that are permanently or removably coupled, or the like). The upper flange 62 of the first shoe member 60 is operatively coupled to the door 2 (e.g., the interior door face 4, the push side of the door, or the like) through the use of one or more shoe connectors 56 (e.g., clips, tabs, fasteners, such as screws, bolts, rivets, pins, or the like). The lower flange 64 may extend below at least a bottom edge 12 of the door 2, and in some embodiments to a location that is adjacent the opposing face of the door 2 (e.g., the outer door face 6). For example, the lower flange 64 may be perpendicular with the upper flange 62 and parallel with the bottom edge 12 of the door 2. As such, it should be understood that an inner surface of the lower flange 64 may touch the bottom edge 12 of the door 2; however, it should be understood that the lower flange 64 may be offset from the bottom edge 12 of the door. In alternate embodiments, the lower flange 64 may be angled inwardly toward the bottom edge 12 of the door 2 or angled away from the bottom edge 12 of the door (e.g., converging to or diverging away from the bottom edge 12 of the door). Moreover, as illustrated in FIG. 5, the lower flange 64 of the first shoe member 60 may comprise one or more channels 66 (e.g., a first channel 68, a second channel 69, an intumescent channel, or the like) that are configured to receive one or more gaskets 100, which will be described in further detail herein.

The second shoe member 70 may comprise a planar-shaped member, which may have a straight portion and/or one or more bends, may be entirely straight, or the like. The second shoe member 70 is operatively coupled to the door 2 (e.g., the outer door face 6, pull side of the door, or the like) through the use of the one or more shoe connectors 52. A portion of the second shoe member may extend to a location adjacent the bottom edge 12 of the door 2, or a portion of the second shoe member 70 may extend past the bottom edge 12 of the door 2.

The door shoe 50 (e.g., the first shoe member 60 and the second shoe member 70) may be operatively coupled to the door 20 at different locations on the first face 4 and/or the second face 6 to account for different gap sizes between the bottom edge 12 of the door and the floor. As such, the door shoe 50 may cover door gaps that range from ¾″ to 1½″ (or any range within, overlapping, or outside of this range). Consequently, in some embodiments a door shoe cavity 80 may be created between the bottom edge 12 of the door 2 and the door shoe 50 (e.g., inner surfaces of the first shoe member 60 and the second shoe member 70).

The door shoe 50 may comprise one or more intumescent portions 82 within the cavity 80 (e.g., one or more inner intumescent portions or cavity intumescent portions on an inner surface of the first shoe member 60, the second shoe member 70, or the like), and/or outside of the cavity 80 between the one or more gaskets 100 and/or within the one or more channels 66 of the lower flange 64 (e.g., one or more outer intumescent portions or gasket intumescent portions). The one or more intumescent portions aid in fire resistance by expanding and filling the shoe cavity 80, the spaces between gaskets 100, and/or within the one or more channels 66 of the lower flange 64 in response to a fire.

While the embodiment illustrated in FIGS. 1 and 3 through 5 is described above, in other embodiments of the invention, both the first shoe member 60 and the second shoe member 70 may be L-shaped members. For example, the first shoe member 60 may comprise the first upper flange 62 and the first lower flange 64, and the second shoe member 70 may comprise a second upper flange 72 and a second lower flange (not illustrated). In this configuration it should be understood that the upper flange 62 of the first shoe member 60 is operatively coupled to the door 2 (e.g., the interior door face 4, or the like) through the use of one or more shoe connectors 56, while the lower flange 64 may extend below at least a bottom edge 12 of the door 2. Furthermore, the second upper flange 72 of the second shoe member 70 may be operatively coupled to the door 2 (e.g., the outer door face 6, or the like) through the use of one or more shoe connectors 56, and the second lower flange (not illustrated) may extend below at least a bottom edge 12 of the door 2. It should be understood that the first lower flange 64 and the second lower flange (not illustrated) may extend adjacent to each other at any location on the bottom edge 12 of the door 2 (e.g., adjacent the inner door face 4, adjacent the outer door face 6, adjacent the middle of the bottom edge 12 of the door, or the like).

While the door shoe 50 is disclosed as having two members within one or more flanges, it should be understood that in other embodiments the door shoe 50 may have any number of members having any number of flanges.

Regardless of the number of members and flanges, the door shoe 50 may comprise a door shoe thermal break 59. For example, the first shoe member 60 and the second shoe member 70 are operatively coupled to the door 2 with a space formed between the members such that the door shoe 50 has a thermal break 59 extending along the length of the door shoe 50. As will be described in further detail herein, the thermal break 50 aids in restricting heat transfer from the second shoe member 70 directly to the first shoe member 60 (or vice versa). Consequently, the thermal break 59 does not allow heat from a fire to pass directly from the second shoe member 70 to the first shoe member 60, which extends the life of the first shoe member 60 when the door shoe 50 is exposed to a fire.

It should be understood that the door shoe 50, and in particular, the first shoe member 60 and/or the second shoe member 70 may be made from any type of material such as composites, plastics, steel, aluminum, or other metals. However, it should be understood that in particular embodiments, the first shoe member 60 and the second shoe member 7 may be made of aluminum. When made of aluminum, the product may be formed from a number of processes, such as extruded, stamped, bent, rolled, or the like. Moreover, when made of aluminum the door shoe 50 can be easily trimmed, drilled, or notched in the field to aid in improved installation and maintenance.

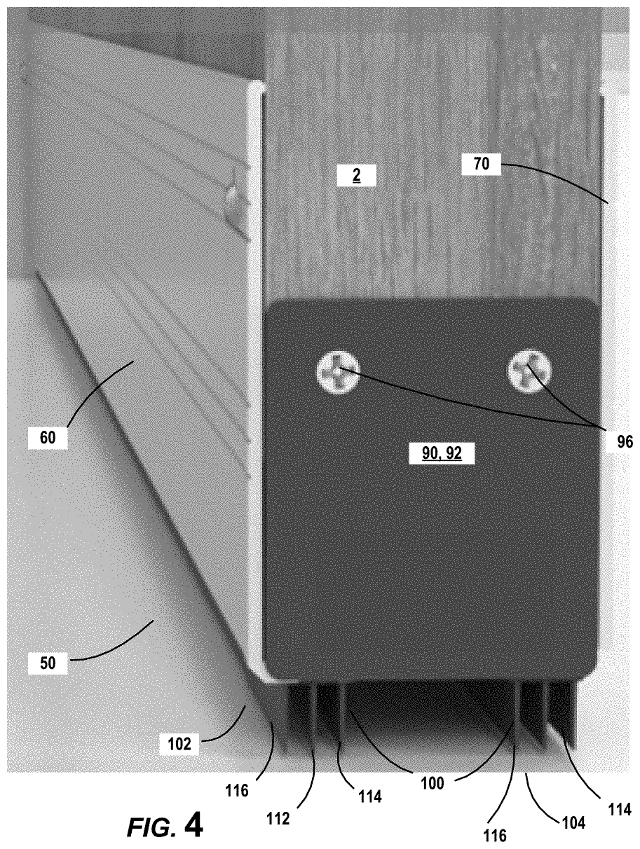

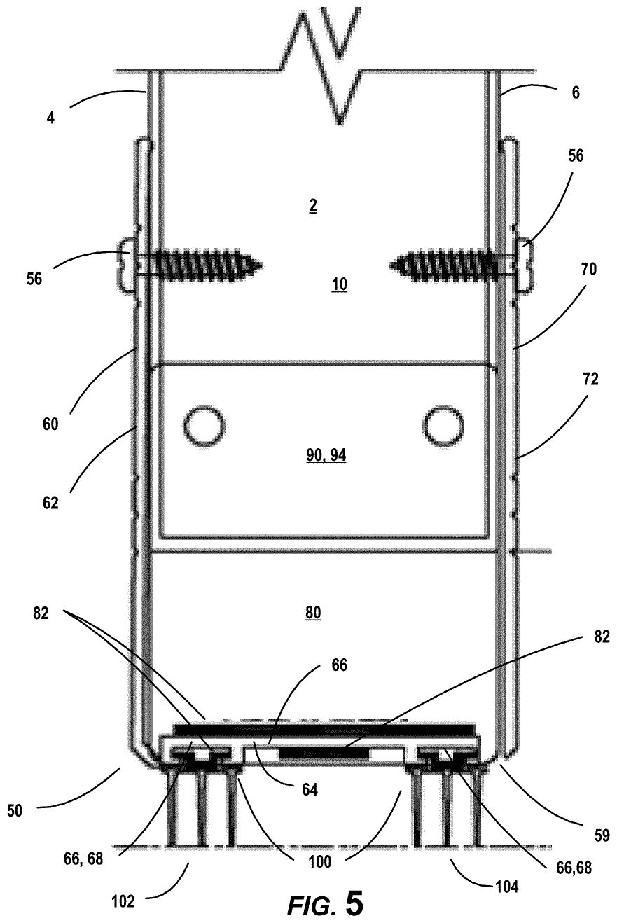

As illustrated in FIGS. 4 and 5, the door shoe 50 may further comprise one or more gaskets 100. The one or more gaskets 100 may be operatively coupled to the first shoe member 60 and/or the second shoe member 70. For example, the one or more gaskets 100 may be pushed into, slid through, snapped into place, or the like within the one or more channels 66 of the lower flange 64. As illustrated in FIGS. 4 and 5, a first gasket 102 and a second gasket 104 may be operatively coupled to the first shoe member 60. However, it should be understood that the first gasket 102 and the second gasket 104 may be operatively coupled to the second shoe member 70. In other embodiments the first gasket 102 may be operatively coupled to the first shoe member 60, while the second gasket 104 may be operatively coupled to the second shoe member 70. As illustrated in FIGS. 4 and 5, the first gasket 102 may be located adjacent the interior face 4 of the door 2, while the second gasket 104 may be located adjacent the exterior face 6 of the door 2.

The one or more gaskets 100 may be any type of gasket (e.g., seal, sweep, open—such as crescent, or the like, closed—such as tubular, semi-circular, or the like, and/or other type of gasket). In some embodiments, the one or more gaskets 100 may comprise one or more legs 110. The one or more legs 110 of the one or more gaskets 100 may engage with the floor (e.g., solid floor that extends between the interior and exterior of the door 2, a threshold located below the door 2, or the like) to provide for air, fire resistance, sound resistance, or the like. It should be understood that in some embodiments each of the gaskets 100 may comprise a central leg 112, and outer leg 114, and/or an inner leg 116. In other embodiments the legs 110 may comprise additional legs (not illustrated). The one or more gaskets 100 may extend from the flanges of the door shoe 50 towards the floor for engagement with the floor (e.g., any type of flooring, a threshold, or the like). In some embodiments the one or more gaskets 100 may at least be partially made of intumescent material.

As previously discussed, the door shoe 50 may cover door gaps that range from ¾″ to 1½″ (or any range within, overlapping, or outside of this range). That is, the height of the first shoe member 60 and the second shoe member 70 alone, or in combination with the height of the one or more gaskets 100, allow the door shoe 50 to be placed at different positions adjacent the bottom edge 12 of the door 2. As such, the lower flange 64 may contact the surface of the bottom edge 12 of the door, and an end of the second shoe member 70 may be located adjacent the bottom edge 12 of the door 2 for coverage of a minimum gap. Alternatively, a portion of the door shoe 50 (e.g., the lower flange 64 of the first shoe member 60, an end of the second shoe member 70, or the like) may extend past the bottom edge 12 of the door 2 to cover larger gaps. Consequently, in some embodiments the bottom edge 12 of the door 2 and the interior surfaces of the door shoe 50 form a door shoe cavity 80 below the bottom edge 12 of the door 2. As such, the door shoe 50 may further comprise one or more end caps 90 (e.g., a proximal end cap 92, a distal end cap 94, or the like) that may be operatively coupled to the door 2 and/or the door shoe 50. For example, the end caps 90 may be operatively coupled to the door 2 through end cap connectors 96 (e.g., clips, tabs, fasteners, such as screws, bolts, rivets, pins, or the like). The one or more end caps 90 may cover at least a portion of the door 2 and a portion of the door shoe cavity 80 formed by the bottom edge 12 of the door 2 and the first shoe member 60 and/or the second shoe member 70.

It should be understood that door systems 1 may be subject to codes, such as fire resistance codes. In particular, NFPA80 is a regulatory code that describes various aspects of fire doors. NFPA80 indicates the clearances (dimension from door edge 8, 10, 14 to frame 20) that are allowed around the top and vertical edges of a fire door. NFPA80 specifically may require that the gaps may be ⅛″ for wood doors; ⅛″+/− 1/16″ for metal doors, or the like. NFPA80 also indicates that the allowable clearance at the bottom of the door (dimension from bottom edge 12 to top of finished floor) is allowed to be up to ¾″ maximum. Clearances around a fire door will ensure proper function and cycling, not only during normal operation, but also in the event of a fire. Appropriate clearances also make certain that other hardware, which may be attached to the door or the frame, will function accurately. Moreover, these specific requirements may change over time and/or other codes may require other gap sizes between door edges and a frame and/or floor.

Furthermore, NFPA80 requires periodic fire door inspections by a licensed professional. In addition to these inspections, each door repair must be documented in a maintenance log. This log will include regulatory certifications and pertinent information about products added to the door that will verify they are compliant with fire and smoke codes, where applicable. When any clearances of a fire-rated opening exceed the required recommendations outlined in NFPA80 or other codes, the door shoe 50 of the present disclosure can assist with bringing a door back into compliance. The door shoe 50 of the present invention may be installed on any type door 2 (e.g., wood, metal, or the like) without having to remove the door 2 from the opening, thus saving time and costs on maintenance

The door shoe 50 may meet fire resistance testing, such as UL 20/45/60/90 or the like fire ratings. In particular, the door shoe 50 of the present invention aids in meeting the fire resistance due in part to the thermal break 50 between the first shoe member 60 and the second shoe member 70 through the thermal break 59, the one or more gaskets 100, and/or the intumescent portions 82. For example, during a fire, the second shoe member 70 located on a face of the door 2 exposed to a fire would heat up, but since there is no bridging between the second shoe member 70 and the first shoe member 60, the second shoe member 70 does not thermally transfer heat directly to the first shoe member 60 due to the presence of the thermal break 59. Moreover, the two or more gaskets 100 having the two or more legs 110 may also aid in providing fire resistance. That is, while an outer leg 114 may begin to melt, a center leg 112 and/or inner leg 116 may provide additional fire resistance, and moreover, when the second gasket 104 located adjacent the second shoe member 70 melts due to the heat from a fire, the first gasket 102 with the two or more legs 110 may provide additional fire resistance. Further, when the intumescent portions are exposed to fire, they expand to fill any gaps, such as the door shoe cavity 80 and/or gaps located between the gaskets 100 and/or legs 110 thereof. As such, in particular embodiments the door shoe 50 may aid in allowing the door system 1 to meet a UL 90 fire resistance (e.g., 90 minute fire rating).

As described herein, the shoe 50 allows for bringing door systems 1 within code, such as to meet fire resistance codes. While the door shoe 50 is described herein as being utilized adjacent the bottom edge 12 of the door 2, similar configurations, or other configurations having different types of thermal breaks 59, gaskets 100, and/or intumescent portions 82 may be used in order to create a door system 1 that meets code and/or fire resistance requirements. As such, it should be understood that the concepts and features described and used with respect to the door shoe 50 may further be used with respect to a header seal 30 and/or side jamb seals (not illustrated, but located between the side door edges 8, 10) that may be used to seal the door edges with the stop flanges, jamb flanges, and/or face flanges of the one door frame 20.

FIG. 6 illustrates a process for manufacturing and/or installing a door shoe 50 on a new or existing door 2 (e.g., new installation or retrofit of an existing door). As illustrated in block 202, the door shoe 50, such as the first shoe member 60 and the second shoe member 70 may be manufactured. For example, the first shoe member 60 and the second shoe member 70 may be extruded, stamped, bent, rolled, or formed in any other way. The door shoe 50 may be formed in customized sizes (e.g., length), may be formed in standard sizes (e.g., lengths that can be trimmed for different door widths), or the like. The door shoe 50 may be formed of aluminum and/or another type of material.

Block 204 of FIG. 6 further illustrates that the one or more gaskets 100 may be assembled to the door shoe 50 (e.g., the first shoe member 60, the second shoe member 70, or the like). The assembly may occur during manufacturing, on-site before installation, or the like). The one or more gaskets may be press, slid, snapped, or the like into a door shoe channel 66 of the door shoe 50 (e.g., door shoe channel 66 located in the first shoe member 60 and/or the second shoe member 70). The door shoe 50 may be shipped to the customer as separate components or in a partially pre-assembled state.

FIG. 6 further illustrates in block 206 that the door shoe 50 may be trimmed based on a door width on which the door shoe 50 may be assembled. In some embodiments, the door shoe may be trimmed (e.g., one or more of the ends of the door shoe are trimmed) on site after an installer identifies the door width. Since the door shoe 50 may be made out of aluminum, an installer may be able to trim the door shoe 50 more easily on-site without the need for industrial machinery (e.g., can use a circular saw, or the like). The door shoe 50 may be trimmed before or after the gaskets 100 are installed.

Block 208 of FIG. 6 further illustrates that the door shoe 50 may be positioned on the door 2, such that one or more gaskets 100 will engage (e.g., touch, or the like) the floor in order to cover a door gap. The door shoe 50 may be positioned in order to determine where the door shoe 50 should be located on the door 2 before it is operatively coupled to the door 2.

FIG. 6 illustrates in block 210 that the door shoe 50 is assembled to the door 2. For example, the first shoe member 60 may be operatively coupled to a face (e.g., interior face) of the door 2 through the use of one or more door connectors 56. For example, screw(s) may be driven through door shoe apertures (e.g., pre-formed through apertures, apertures partially located in the door shoe—such as grooves in the door shoe, apertures created by the drilling of the door shoe, or the like) and into the door 2. Moreover, the second shoe member 70 may be operatively coupled to a face (e.g., external face) of the door 2 through the use of the one or more door connectors 56. The second shoe member 70 is operatively coupled such that an end of the second shoe member 70 is located adjacent an end of the lower flange 64 of the first shoe member, but in a way that creates a thermal break 59 between the first shoe member 60 and the second shoe member 70. The inner surfaces of the first shoe member 60, the second shoe member 70, and the surface of the bottom edge 12 of the door 2 form a door shoe cavity 80 below the door 2 and above the floor.

As further illustrated by block 212 of FIG. 6, one or more end caps 90 are operatively coupled to the door 2 and/or the door shoe 50 in order to cover the door shoe cavity 80. In some embodiments, the one or more end caps 90 are operatively coupled to the door 2 and/or the door shoe 50 though the use of one or more end cap connectors 96. For example, screws may be driven through end cap apertures (e.g., pre-formed through apertures, apertures partially located in the door end cap, apertures created by the drilling of the door shoe, or the like) and into the door 2.

As previously described, in the event of a fire, the second shoe member 70 will heat up but will not directly transfer heat to the first shoe member 60 due to the thermal break 59. The intumescent portions will heat up and expand into the shoe cavity 80 and the gaps between the gaskets. The second shoe member 70 will melt, the first gasket will melt, the intumescent will be degraded, and the lower flange 64 of the first shoe member 60 will melt. However, due to the features of the door shoe 50 described herein, the door system 1 of the present invention may provide fire resistance for at least 90 minutes, which otherwise would have not been possible without the features described herein (e.g., in particular, without the thermal break 59, intumescent portions, and/or two or more gaskets 100 with multiple legs 110).

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as “top,” “bottom,” “side,” “distal,” “proximal,” “upper,” “lower,” “left,” “right,” “horizontal,” “vertical,” “upward,” “downward”, “first”, “second”, “inner”, “outer”, “interior”, “exterior”, or other like terminology merely describe the configuration shown in the figures. The referenced components may be oriented in an orientation other than that shown in the drawings and the terminology, therefore, should be understood as encompassing such variations unless specified otherwise.

It will be understood that when an element is referred to as “operatively coupled” to another element, the elements can be formed integrally with each other, or may be formed separately and put together. Furthermore, “operatively coupled” can mean the element is directly coupled to the other element, or intervening elements may be present between the elements. Furthermore, “operatively coupled” may mean that the elements are detachable from each other, or that they are permanently operatively coupled together.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A door shoe comprising:
a first shoe member configured to be operatively coupled to a first face of a door;
a second shoe member configured to be operatively coupled to a second face of the door; and
one or more gaskets operatively coupled to the first shoe member or the second shoe member;
wherein the first shoe member and the second shoe member are configured to be operatively coupled to the door with a thermal break formed between the first shoe member and the second shoe member.

2. The door shoe of claim 1, wherein the first shoe member or the second shoe member are made from aluminum.

3. The door shoe of claim 1, wherein the first shoe member is an L-shaped member having an upper flange and a lower flange.

4. The door shoe of claim 3, wherein the lower flange of the first shoe member is configured to extend across a majority of a bottom edge between the first face and the second face of the door.

5. The door shoe of claim 1, wherein the second shoe member is a planer-shaped member having at least one straight portion.

6. The door shoe of claim 1, wherein the first shoe member is a first L-shaped member having a first upper flange and a first lower flange, and wherein the second shoe member is a second L-shaped member having a second upper flange and a second lower flange, and wherein the first upper flange of the first shoe member is configured to be operatively coupled to the first face of the door and the second upper flange is configured to be operatively coupled to the second face of the door.

7. The door shoe of claim 1, further comprising:
one or more end caps, wherein the one or more end caps cover at least a portion of the door and a portion of a door shoe cavity formed between a bottom edge of the door and the first shoe member or the second shoe member.

8. The door shoe of claim 1, wherein the one or more gaskets comprise:
a first gasket adjacent the first face of the door; and
a second gasket adjacent the second face of the door.

9. The door shoe of claim 1, wherein the one or more gaskets comprise two or more legs, wherein the two or more legs are configured to engage with a floor.

10. The door shoe of claim 1, wherein the one or more gaskets extend from the first shoe member or the second shoe member adjacent a bottom edge of the door between the first face and the second face towards a floor.

11. The door shoe of claim 10, wherein the first shoe member or the second shoe member comprise a first channel and a second channel, wherein a first gasket is configured to be operative coupled to the first channel and a second gasket is configured to be operatively coupled to the second channel, and wherein the door shoe further comprises:
an outer intumescent portion configured to be operatively coupled to an outer surface of a lower flange of the first shoe member or the second shoe member between the first gasket and the second gasket; and
an inner intumescent portion configured to be operatively coupling to an inner surface of the lower flange of the first shoe member or the second shoe member.

12. A door system comprising:
a door; and
a door shoe operatively coupled to the door, wherein the door shoe comprises:
a first shoe member operatively coupled with a first face of the door;
a second shoe member operatively coupled with a second face of the door; and
one or more gaskets operatively coupled to the first shoe member or the second shoe member;
wherein the first shoe member and the second shoe member are operatively coupled to the door with a space formed between to create a thermal break between the first shoe member and the second shoe member.

13. The door system of claim 12, wherein the first shoe member and the second shoe member of the door shoe are made from aluminum.

14. The door system of claim 12, wherein the first shoe member is an L-shaped member having an upper flange and a lower flange, and wherein the second shoe member is a planar-shaped member.

15. The door system of claim 14, wherein the lower flange of the first shoe member extends across a majority of a bottom edge between the first face and the second face of the door.

16. The door system of claim 12, further comprising:
one or more end caps, herein the one or more end caps cover at least a portion of the door and a portion of a door shoe cavity formed between a bottom edge of the door and the first shoe member or the second shoe member.

17. The door system of claim 12, wherein the one or more gaskets comprise:
a first gasket adjacent the first face of the door; and
a second gasket adjacent the second face of the door.

18. The door system of claim 12, wherein the one or more gaskets comprise two or more legs, wherein the two or more legs are configured to engage with a floor.

19. The door system of claim 12, wherein the first shoe member or the second shoe member comprises a first channel and a second channel, wherein a first gasket is operatively coupled to the first channel and a second gasket operatively coupled to the second channel, wherein the first gasket and the second gasket extend from the first shoe member or the second shoe member adjacent a bottom edge of the door between the first face and the second face towards a floor, and wherein the door shoe further comprises:
an outer intumescent portion operatively coupled to an outer surface of a lower flange of the first shoe member or the second shoe member between the first gasket and the second gasket; and
an inner intumescent portion operatively coupled to an inner surface of the lower flange of the first shoe member or the second shoe member.

20. A method of installing a door shoe to a door, the method comprising:
assembling a first shoe member to a first face of the door using one or more door shoe connectors; and
assembling a second shoe member to a second face of the door using the one or more door shoe connectors;
wherein a thermal break is located between the first shoe member and the second shoe member; and
wherein one or more gaskets are operatively coupled to the first shoe member or the second shoe member and engage a floor.
